(19) United States
(12) Patent Application Publication
(10) Pub. No.: US 2005/0005146 A1
(43) Pub. Date: Jan. 6, 2005

(54) Methods, data structures, and systems for authenticating media stream recipients

(75) Inventor: Arben Kryeziu, Wailuku, HI (US)

Correspondence Address: Schwegman, Lundberg, Woessner & Kluth, P.A., P.O Box 2938, Minneapolis, MN, 55402, US

(73) Assignee: Maui X-tream, Inc.

(21) Appl. No.: 10/613,721

(22) Filed: Jul. 3, 2003

(51) Int. Cl. H04L 9/32

(52) U.S. Cl. 713/193

(57) ABSTRACT

Methods, data structures, and systems authenticate recipients of media streams. A media stream includes a self-installing and self-executing media player and media content. The media player communicates with an authentication service after it self-installs and self-executes. The media player provides authenticating information about a media stream recipient. The authentication service uses the information for authenticating the recipient for access to the media content. The authentication service provides an authentication token for an authorized recipient. Once a valid authentication token is received by the media player, the media player plays the media content for the authorized recipient.

### TECHNICAL FIELD

Embodiments of the present invention relate generally to media streaming, and more particularly to authenticating media recipients for access to media content associated with a media stream.

### BACKGROUND INFORMATION

Network transmission of media streams has become commonplace in today's electronic economy. Individuals now consume media streams to video conference, watch television, watch movies, listen to radio, transmit personal videos, and talk with one another.

The pervasiveness of media streams has created a number of licensing and royalty problems for content providers. For example, once the media stream is available in an electronic environment and transmitted over a network, the media stream can be acquired by individuals that are not authorized to view the media stream and have not paid the content provider for access.

Conventionally, licensing and royalty problems have been addressed by the content providers by using standard encryption techniques, such as Public Key Infrastructure (PKI) (Public and Private Key pairs uses to encrypt keys). However, once an authorized recipient successfully decrypts a key, the media stream is available for playing within conventional media players in a format that can be subsequently transmitted by an authorized recipient to an unauthorized recipient (downstream recipient). Thus, media streams, which are not properly licensed by content providers continues to be a growing concern for the media content providers. Moreover, conventionally there is no effective technique for restricting downstream recipients from subsequently re-transmitting the media streams to other unauthorized downstream recipients.

Therefore, there is a need for improved implementations and techniques for authenticating media stream recipients. These implementations and techniques should be capable of validating licensing and royalty requirements of a content provider, each time the media stream is played. In this way, authorized recipients of the media stream cannot provide access to unauthorized recipients (downstream recipients).

### BRIEF DESCRIPTION OF THE DRAWINGS

FIG. 1 is a flow diagram of a method for authenticating a media stream recipient, in accordance with one embodiment of the invention.

FIG. 2 is a diagram depicting a media authentication data structure, in accordance with one embodiment of the invention.

FIG. 3 is a diagram of a media stream authentication system, in accordance with one embodiment of the invention.

### SUMMARY OF THE INVENTION

In various embodiments of the present invention, techniques for automatically authenticating media stream recipients are taught. A media stream includes a self-installing and self-executing media player and media content. The media player communicates with an authentication service to acquire an authentication token. The authentication token is used by the media player to grant access to and to play the media content for an authorized recipient.

More specifically and in one embodiment of the present invention, a method to authenticate a media stream recipient is presented. An authentication request is automatically received from a media player when a recipient attempts to play a media stream. The media player is part of the media stream. Further, the recipient is checked to determine if the recipient is authorized to play media stream. If the recipient is authorized, then an authentication token is sent to the media player.

### DESCRIPTION OF THE EMBODIMENTS

Novel methods, data structures, and systems for authenticating media stream recipients are described. In the following detailed description of the embodiments, reference is made to the accompanying drawings, which form a part hereof, and in which is shown by way of illustration, but not limitation, specific embodiments of the invention that may be practiced. These embodiments are described in sufficient detail to enable one of ordinary skill in the art to understand and implement them, and it is to be understood that other embodiments may be utilized and that structural, logical, and electrical changes may be made without departing from the spirit and scope of the present-disclosure. The following detailed description is, therefore, not to be taken in a limiting sense, and the scope of the embodiments of the inventions disclosed herein is defined only by the appended claims.

As used herein the phrase “media stream” includes media content/data that is related to multimedia such as, by way of example only, audio, video, graphical, image, text, and combinations of the same. Media streams of this invention also include a self-installing and self-executing media player, such as the one described in U.S. patent application Ser. No. 10/369,017, entitled: “Methods, Data Structures, and Systems for Processing Media Data Streams,” filed on Feb. 19, 2003, the disclosure of which is hereby incorporated by reference.

The media streams can be streamed using conventional transferring techniques, such as by breaking media stream up into configurable byte chunks, blocks, or frames and serially transmitting these pieces over a network to a one or more recipients' computing devices. The network can be hardwired (e.g., direct (point-to-point), indirect (e.g., Wide Area Network (WAN), such as the Internet), and others). The network can also be wireless (e.g., Infrared, Radio Frequency (RF), Satellite, Cellular, and others). Furthermore, the network can be a combination of hardwired and wireless networks interfaced together.

A content provider is an entity that is authorized to electronically distribute the media content of the media stream. Thus, content provider may be an entity that originally creates the media content for direct electronic distribution, or the content provider may be an entity that acquires a license to distribute the media content. The content provider can be represented as one or more electronic applications or services within a computer-accessible medium over a network.

An authentication service is one or more electronic applications that provide authentication services to a media player of the media streams. The authentication service can receive a variety of authenticating information from the media player, such as, and by way of example only, the identity of a recipient of the media content, identification for a computing device of the recipient, setting data associated with the computing device's environment, identification for a content provider, and the like. In some embodiments of this invention, the authentication service communicates with a licensing service to determine if a particular recipient is authorized to play the media content. The licensing service can also be a digital certification authority.

The authentication service provides an authentication token back to the media player on a requesting recipient's computing device. The authentication token is a key informing the media player that the media content can be played for the authorized recipient. In one embodiment, the authentication token is a key that is encrypted using any ad-hoc or conventional encryption technique, such as, and by way of example only, private and public key pairs associated with PKI techniques. The private key can be a private key of the media player and known only to the authentication service and the media player. The public key can be a public key of the authentication service.

The authentication token can also be a hidden file/data that is installed by the authentication service directly within the recipient's computing environment. Alternatively, the media player can be used to install the hidden file/data. In still other embodiments, the authentication token is nothing more than an electronic notification sent from the authentication service to the media player, when an authorized recipient is verified.

In still other embodiments, the authentication token is a more complex data structure that provides licensing restrictions and limitations to the media player. For example, the authentication token may provide data to the media player, which instructs the media player to permit media content play for a specified period of time. Moreover, the authentication token can indicate that the media player need not re-contact the authentication service for all subsequent play requests made by an identified recipient.

A recipient is an electronic representation of an entity. The entity can be a user or another electronic application. The recipient receives the media stream that includes both the media player and the media content.

It is not significant as to how or from whom the recipient received the media stream, although such information can be retained by the media player each time the media stream is transmitted from one recipient to another downstream recipient. When such information is retained, the information may be useful for purposes of authenticating a particular recipient. For example, a particular license may authorize first recipients of the media stream, where the first recipients acquire the media stream from an identified sender. In these situations, retention of certain recipients or senders by the media player may prove useful to proper authentication, when the media player interacts with the authentication service.

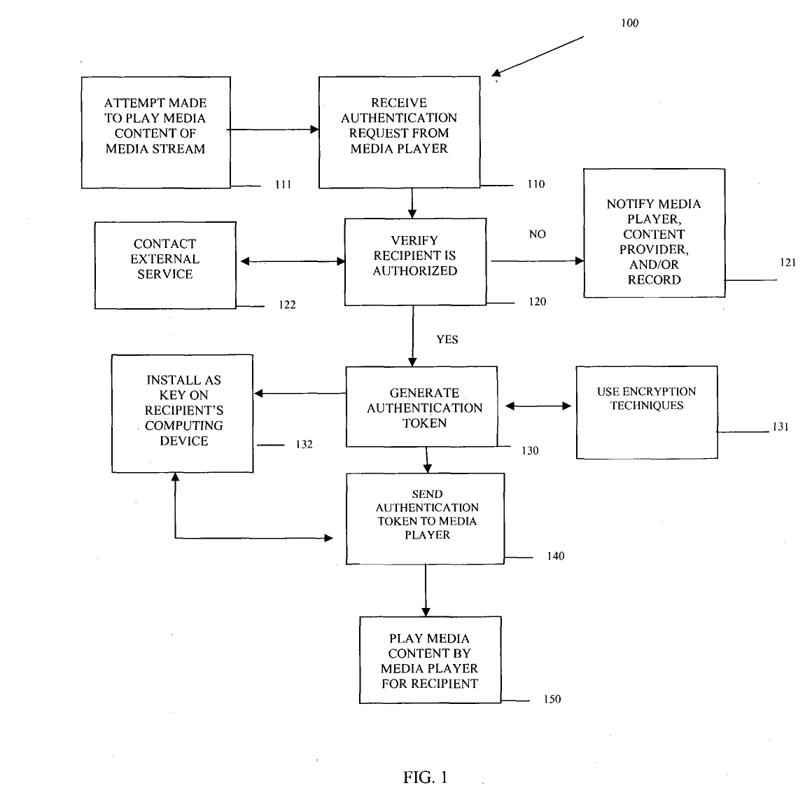

FIG. 1 illustrates a flow diagram of a method 100 for authenticating media stream recipients, in accordance with one embodiment of the invention. Method 100 is implemented by one of more software applications on computer accessible media and is executed by a computing device (e.g., any device having processing and memory capabilities). Further, in one embodiment, the processing of the method 100 is implemented as an authentication service accessible to network client computing devices via a network connection. Such an authentication service is capable of interacting with zero or more external services, when verifying a recipient for access to the media stream. For example, the authentication service may request information from a licensing service or a digital certificate authority.

At 110 an authentication request is received from a media player. The media player is embedded with the media stream and is included with media content. The format of the media content is known only to the media player, such that the media player is needed to play the media content. The media player is self-installing and self-executing on a computing device of a recipient that is attempting to play the media content.

When the recipient attempts to play the media content at 111, the media player determines if the recipient is authorized or has a valid license for the media content. If the recipient has a locally-accessible authentication token from a previous authorization, then the media player plays the media content for the recipient, assuming that any license associated with the authentication token is currently valid. However, if the media player is required by the strictures of the authentication token or if the recipient is making a first request to play the media content, then the media player generates authentication information, which is sent to the processing of method 100 at 110.

When an authentication request is received from a media player at 110, the authentication information associated with the request is inspected at 120 to determine if a valid authentication token can be issued to the media player. The authentication information can include an identity for the recipient, an identification for the media content or stream, an Internet Protocol (IP) address for the recipient's computing device, setting for the computing device's electronic environment, an identification for the requesting media player, identifications for any previous sender or recipient of the media stream, an identity of a content provider that owns the media stream, and the like.

Accordingly, the authentication information is used for verifying that the recipient is permitted to play the media content at 120. Verification logic and processing can be dependent upon the licensing or access rights required by a content provider of the media content. These licensing limitations can be locally obtained by the processing of method 100, such as when the limitations are represented in a local data structure of file. Alternatively, these licensing limitations can be obtained from the processing of the method 100 by interacting or communication with an external service, as is depicted at 122. The external service can be a licensing service or a digital certification service. Once the processing of the method 100 determines that a recipient is either authorized or not authorized to play the media content, communication is re-established with the originally requesting media player.

If, at 121, a recipient is determined to not have proper authorization, then notification of such is transmitted to the media player. Additionally, in some embodiments, any such unauthorized access attempt can be communicated to the content provider and/or recorded by the processing of the method 100 in an electronic log data structure or file. Moreover, any such notification can include the authentication information (or selective portions of the authentication information) that was originally sent by the media player. In this way, with various embodiments of this invention, content providers can actively and automatically monitor their content data for licensing violations. Conventionally, such monitoring techniques have not been available for downstream recipients of media content.

If, the recipient is authorized to play the media content, then, at 130, an authentication token is generated. In one embodiment, the authentication token is nothing more than an electronic acknowledgment of confirmation that is sent by the processing of the method 100 to the requesting media player. In other embodiments, the authentication token is actually a collection of data that defines the metes and bounds of any authorized access for the authorized recipient. In this way, the authentication token can provide processing limitations to the media player via the authentication token and licensing access rights can be customized by content providers for their media content.

In some embodiments, the authentication token is an encrypted licensing key, which is encrypted using any conventional or ad-hoc encryption techniques, as is depicted at 131. For example, the processing of the method 100 can use a private key associated with the processing of the method 100 and a public key of the media player or recipient to produce an encrypted authentication token. In other embodiments, the private key of the media player can be known only to the processing of the method 100 and the media player, such that the processing of the method 100 can encrypt the authentication token using the public key associated with the processing of the method 100 and the private key of the media player. Of course a variety of public and private key encryption techniques can be used with embodiments of this invention. All such conventional or ad-hoc developed techniques are intended to be covered by this invention.

In yet more embodiments, the authentication token is intended to be installed as a hidden file/data within the recipient's computing environment. Thus, at 132, the processing of the method 100 can automatically install the authentication token on the recipient's computing device, assuming such write access is provided by the recipient's computing device.

If the processing of the method 100 independently installs the authentication token on the recipient's computing device, then the authentication token is acquired by the media player at 140 and used to play the media content for the recipient at 150.

In other embodiments, the media player manages the authentication token, independent of the processing of the method 100. In these embodiments, at 140, the authentication token is sent to the media player where the media player uses the token to play the media content for the recipient at 150.

In still more embodiments, the media player includes an initial authentication token with the media stream. This authentication token can include a time or event limitation, such that when the time or event is detected, the media player deletes the media stream and itself from the computing environment of the recipient. Thus, in some embodiments, any initial recipient of the media stream may have only temporary possession of the media stream based on strictures of the authentication token.

In other embodiments, the media player and the media stream only reside in volatile memory and once the media content is consumed, the media content and the media player are no longer available on a recipient's computing device. Thus, should a particular recipient desire to play the media content a second time, the media stream including the media player is reacquired from the service providing the media stream.

In another embodiment, the media stream is initially encoded using a security identification (SID) based on an Internet Protocol (IP) address, a range of IP addresses, an Uniform Resource Locator (URL), or a list of URLs. In these embodiments the media player will only play the media content of the media stream for a recipient if the recipient's computing environment is properly identified by the encoded SID. Thus, even if a recipient's computing device is somehow able to acquire an authorized authentication token, the media content will still not play if the computing device's SID is not also identified in the media stream. This feature can also be used to prevent a computing device having the proper SID and authentication token from re-streaming the media stream to downstream recipients, when the recipient attempting to re-stream is not authorized to re-stream the media stream.

In yet further embodiments, the initial authentication token can include limitations that restrict the re-transmission of the media stream from an initial recipient to downstream recipients. Thus, if an authorized initial recipient attempts to re-stream the media stream to another downstream recipient, the media player prevents this before it occurs. However, if the authorized initial recipient attaches the stream in an email and sends it, then when the media player installs and executes on the downstream recipient's computing device, the authentication token will either not exist or be invalid such that the media stream is useless to the unauthorized downstream recipient.

It is now apparent how the access to media content can be effectively controlled in an electronic environment. These processing techniques permit licensing and royalty enforcement on any downstream recipients of the media content. Conventionally, such enforcement could only occur with initial or first recipients of the media content.

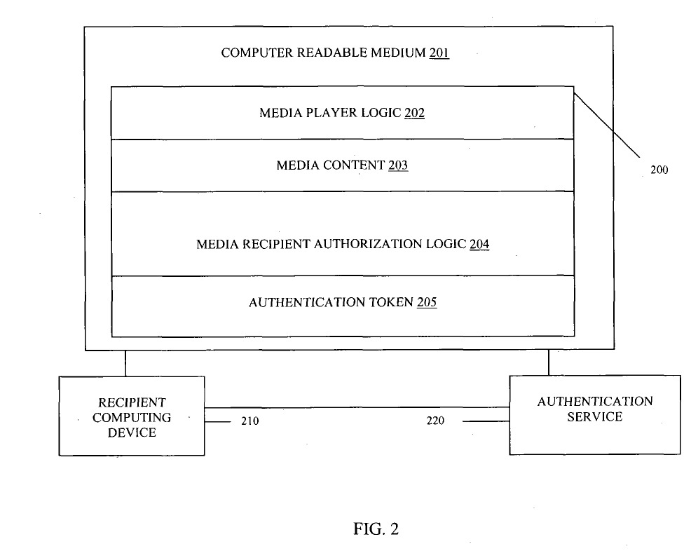

FIG. 2 is a diagram depicting one media authentication data structure 200, in accordance with one embodiment of the invention. The media authentication data structure 200 resides in a computer-accessible medium and is consumed by one or more electronic applications processing on one or more computing devices over a network. Moreover, the media authentication data structure 200 need not contiguously store all of its 200 components within memory or storage locally accessible to a single computing device, since the media authentication data structure 200 can be logically assembled during processing or consumption by one or more electronic applications and one or more computing devices.

The media authentication data structure 200 is embodied as a media stream having media player logic 202, media content 203, and media authentication logic 205. Optionally, the media authentication data structure 200 also includes an authentication token 205.

The media authentication data structure 200 is at least partially consumed or modified on a recipient's computing device 210. Consumption or modification occurs once the media authentication data structure 200 is received on the recipient's computing device, since the media player logic 202 is capable of self-installing and self-executing on the recipient's computing device once received. Once the media player logic 202 begins processing, the media player logic searches for an authentication token 205 that can be used to play the media content 203 for the recipient.

The media player logic 202 includes or is interfaced to the media recipient authorization logic 204. The media recipient authorization logic 204 can locate any existing authentication token 205 by using a pointer reference or other information embedded in the media player logic 202. If such pointer reference or other information is available and does not require further authentication based on the contents of the existing authentication token 205, then the media player logic 202 plays the media content 203 for the recipient on the recipient's computing device 220.

However, if the media recipient authorization logic 204 determines that no existing or valid authentication token 205 is present, then the media recipient authorization logic 204 gathers authentication information for purposes of sending an authentication request to an authentication service 220. The types of authentication information are configurable within the media recipient authorization logic 204. Such information can include, by way of example only, an identity of the recipient, identification for the recipient's computing device 220, settings for the recipient's computing environment, identifications for previous recipients of the media content 203, identification for the media player's logic 202, and the like.

Once the media recipient authorization logic 204 assembles an authentication request with authentication information, the media recipient authorization logic 204 sends the authentication request over a network connection to the authentication service 220.

The authentication service 220 inspects the authentication information of the authentication request and determines whether access can be given to play the media content 203 for this particular request. The validation techniques can be defined by licensing and or royalty constraints imposed by a content provider that owns the media content 203. In some instances, the authentication service 220 contacts external services, such as licensing services and/or digital certification authorities to determine whether access is permissible.

Once the authentication service 220 determines whether access is permissible, the authentication services media recipient authorization logic 204 processing on the recipient's computing device 210 by providing an authentication token 205. However, if access is not permissible, then no authentication token is sent, rather a notification is sent to the media player logic 202 instructing it 202 not to play the media content 203 for the recipient.

The authentication token 205 can be an encrypted key or an encrypted complex data structure. It 205 can be created using any traditional encryption, licensing, or key producing technique. Moreover, it 205 can be created using any custom-developed encryption, licensing, or key producing technique. Thus, the authentication token 205 can be a key that informs the media player logic 202 that it is permissible to grant access to the media content 203. Alternatively, the authentication token 205 includes licensing limitations that drive how the media player logic 202 monitors and provides access to the media content 203.

When the media recipient authorization logic 204 satisfies itself that it can acquire an authentication token 205, then the media content 203 is played for the recipient on the recipient's computing device 220 using the media player logic 202. Thus, it is readily understood that the identity of any particular recipient can be used dynamically and automatically with the media authentication data structure 200 to enforce licensing or royalty requirements dictated by a content provider.

Additionally, in some embodiments, the authentication token 205 can include time or event limitations that are used by the media recipient authorization logic 202, which instructs either the media player logic or the media recipient authorization logic 202 to self destruct the media authentication data structure 200 from the recipient's computing device 210.

In another embodiment, the media data structure 200 resides only temporarily in volatile memory of a recipient computing device 210 and is unavailable and destructed once played by a recipient. In this way, the media data structure 200 is reacquired by the recipient's computing device 210 each time the media content 203 is re-played.

In one embodiment, the authentication service 220 also encodes the media data structure 200 with an SID. This SID can be combined with or be a part of the authentication token 205, such that the recipient computing device's 210 SID needs to match the encoded SID in order for the recipient to play the media content 203. This SID can also be used to prevent a recipient from re-streaming the media data structure 200 to a downstream recipient, when such re-streaming is prohibited by the authentication token 205.

Furthermore, in yet more embodiments, the authentication token 205 can be used by the media recipient authorization logic 202 independently or in cooperation with the media player logic for purposes of preventing an initial recipient from re-streaming the media authentication data structure 200 to a downstream recipient.

The techniques presented with this invention are not exclusively limited to authenticating and validating licenses of the media content 203, since the techniques presented herein are equally useful for ensuring that the media player logic 202 includes a valid license to execute on the recipient's computing device 220 in the first instance.

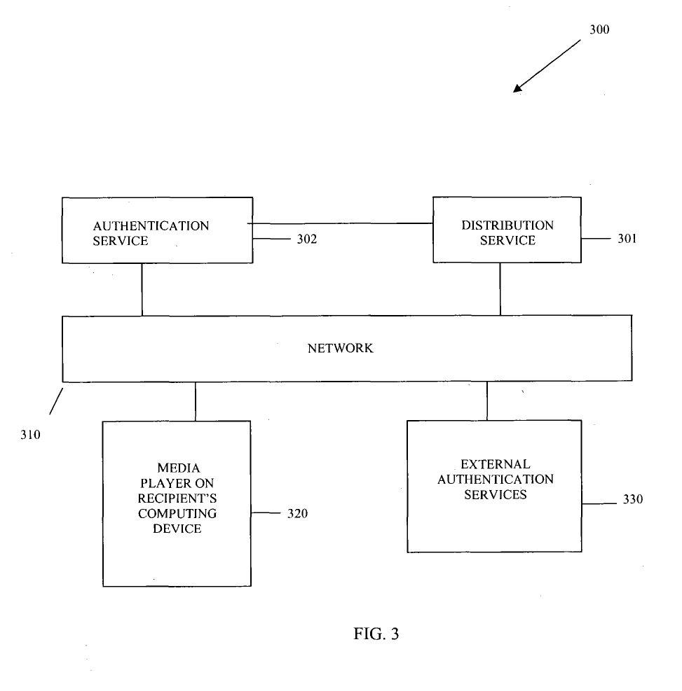

FIG. 3 is a diagram of one media stream authentication system 300, in accordance with one embodiment of the invention. The media stream authentication system 300 is implemented in a computer-accessible medium and is accessible to a variety of electronic applications and services.

The media stream authentication system 300 includes a distribution service 301 and an authentication service 302. The two services 301 and 302 need not be local within the same computing environment, or for that matter processing on the same computing device. Thus, the two services 301 and 302 can be interfaced to one another as needed or desired over a network 310.

The distribution service 301 packages customized media players 320 with media content as media streams. These streams are then distributed over network 310 to a variety of recipient computing devices, where the media content may play for the recipient if the media player 320 of the media stream can acquire authorization for the recipient. The media player 320 is capable of self-installing and self-executing on a recipient's computing device and includes logic for communicating with the authentication service 302.

The authentication service 302 receives authentication requests from the media players 320 when the media players 320 determine that authorization is necessary. When a first recipient attempts for a first time to play the media content, the media player will determine that an authentication request is necessary. Any subsequent attempts by a recipient to replay previously played media content may or may not cause the media player 320 to issue an authentication request to the authentication service 302. Under these circumstances, the dictates of any existing authentication token that is accessible to the media player 320 will determine whether the media player 320 issues an authentication request to the authentication service 302.

The media player 320 gathers authentication information from the media content, the recipient, and/or the recipient's computing device in order to construct the authentication request. When an authentication request is needed, the media player 320 generates the authentication request and transmits it over the network 310 to the authentication service 302.

The authentication service 302 inspects the authentication information of the authentication request and performs the appropriate validation on the information, in order to deny the request, or in order to generate an authentication token. In some embodiments, the authentication service 302 uses one or more external authentication services 330 to assist in the validation process. Some of these services can include licensing services, certificate authorities, and the like.

If an authentication token is generated, then the authentication token can be generated using a variety of traditional or custom-developed techniques. Moreover, the authentication token can be a simple confirmation or a complex data structure that includes licensing limitations defined by a content provider of the media content. Additionally, in one embodiment, the authentication token is a digital signature or a digital certificate.

Once the authentication token is created, the authentication service 302 transmits the token over the network 310 to the media player 320 that initially requested authorization for a recipient to play the media content. When the media player 320 satisfies itself 320 that it has a valid authentication token, then the media content is played for the recipient on the recipient's computing device.

In one embodiment, the authentication token includes strictures that permit the media player 320 to determine when a specific designated time or event occurs satisfying the stricture of the authentication token. Under these circumstances, the media player 320 can self-destruct itself 320 and the media stream from the recipient's computing environment.

In another embodiment, the media stream is only temporarily available on a recipient's computing device in volatile memory or storage and once portions of the media stream are consumed, these portions are no longer available for use on the recipient's computing device. Thus, the media stream including the media player 320 are re-acquired each time the media content is played by a recipient.

In still another embodiment, the media stream is also encoded by the distribution service 301 with an SID, such that when a recipient attempts to play media content associated with a downloaded media stream, the computing environment of the recipient needs to match the encoded SID. This technique can also be used to prevent a recipient from re-streaming the media stream to other downstream recipients, when such re-streaming is prohibited by a content provider.

In yet other embodiments, the authentication token can include strictures that inform the media player to not permit any initial recipient from subsequently re-transmitting the media stream to a downstream unauthorized recipient.

It is now understood how electronic media content can be monitored by content providers for license and royalty conformity. This is achievable with and enforceable against any downstream recipient. Accordingly, with the teachings of this invention, content providers can better control and enforce their intellectual property rights in their media content.

It is to be understood that the above description is intended to be illustrative, and not restrictive. Many other embodiments will be apparent to those of skill in the art upon reviewing the above description. The scope of embodiments of the invention should, therefore, be determined with reference to the appended claims, along with the full scope of equivalents to which such claims are entitled.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Description of the Embodiments, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject mater lies in less than all features of a single disclosed embodiment. Thus the following claims are hereby incorporated into the Description of the Embodiments, with each claim standing on its own as a separate exemplary embodiment.

1. A method to authenticate a media stream recipient, comprising:
automatically receiving an authentication request from a media player when a recipient attempts to use the media player to play a media stream, and wherein the media player is part of the media stream;
verifying that the recipient is authorized to play the media stream; and
sending an authentication token to the media player, if the recipient is authorized.

2. The method of claim 1 wherein the sending further comprises automatically installing the authentication token as a licensing key on a computing device of the recipient, wherein the licensing key can include licensing limitations.

3. The method of claim 1 wherein in automatically receiving, the recipient initially obtains the media player and media stream from a second recipient.

4. The method of claim 1 wherein in verifying, the recipient is verified by externally contacting a licensing service with at least one of an identity of the recipient and an identification of the media stream.

5. The method of claim 1 wherein in sending, the authentication token includes limitations that instruct the media player to self destruct the media stream upon the occurrence of an event or pre-defined time.

6. The method of claim 1 wherein in sending, the authentication token includes limitation that instruct the media player to prevent the recipient from re-streaming the media stream to a downstream recipient.

7. The method of claim 1 wherein in sending, the authentication token is at least one of a digital certificate and a digital signature.

8. A media stream structure residing on a computer readable medium, comprising:
media player logic;
media content; and
media recipient authentication logic included with the media player logic;
wherein when the media stream data structure is received by a computing device, the media player logic automatically installs itself on the computing device and executes the media recipient authentication logic before playing the media content, and wherein the media recipient authentication logic sends an authentication request to an authentication service along with the identity of a recipient of the media content.

9. The media stream data structure of claim 8 wherein the media recipient authentication logic also sends an identification of the media content to the authentication service.

10. The media stream data structure of claim 8 further comprising an authentication token, which is added to the media stream data structure if the identity of the recipient is authorized to play the media content on the computing device by the authentication service.

11. The media stream data structure of claim 10, wherein the authentication token is stored external to the media stream data structure and is identified within the media stream data structure as a pointer reference.

12. The media stream data structure of claim 8 wherein the media recipient authentication logic also sends at least one of settings associated with a computing environment of the computing device and an Internet Protocol (IP) address associated with the computing device to the authentication service.

13. The media stream data structure of claim 8 wherein the authentication service authenticates the identity of the recipient by interfacing with one or more external licensing services.

14. The media stream data structure of claim 8 wherein the media player automatically plays the media content if a valid authentication token is received from the authentication service.

15. A media content authentication system, comprising:
a distribution service for distributing media streams, wherein each media stream includes media content and a self-installing media player; and
an authentication service that subsequently communicates with each media player in order to authenticate access to recipients that attempts to play the media content.

16. The media content authentication system of claim 15 wherein each media player that self-installs contacts the authentication service immediately after it initially installs on a recipient's computing device.

17. The media content authentication system of claim 15 wherein each media player receives an authentication token from the authentication service, if a corresponding recipient is authorized to play the media content.

18. The media content authentication system of claim 15 wherein the authentication service uses a licensing service to authorize a number of the recipients for access to the media content.

19. The media content authentication system of claim 15 wherein the authentication service receives information from each of the media players that is used to authenticate each of the recipients, and the information includes at least one of settings of a computing environment that is executing the media player, an identity of the recipient, and an identification of the media content.

20. The media content authentication system of claim 15 wherein the authentication service returns authentication tokens to each of the media players that have authorized recipients and the authentication tokens are at least one of a digital certificates, digital signatures, encrypted data, and hidden data.
